(19) United States
(12) Patent Application Publication
(10) Pub. No.: US 2019/0082446 A1
(43) Pub. Date: Mar. 14, 2019

(54) Uplink Transmission Handling in the Presence of Tune-Aways

(71) Applicants: Jiming GUO, San Diego, CA (US); Nawal Kishor MISHRA, San Diego, CA (US); Chintan Shirish SHAH, San Diego, CA (US); Zhongsheng LI, San Diego, CA (US); Lichen LIU, San Diego, CA (US); Bharath SAKINALA, San Diego, CA (US); Praveen PERURU, San Diego, CA (US); QUALCOMM Incorporated, San Diego, CA (US)

(72) Inventors: Jiming GUO, Beijing (CN); Nawal Kishor MISHRA, Hyderabad (IN); Chintan Shirish SHAH, Chula Vista, CA (US); Zhongsheng LI, Shanghai (CN); Lichen LIU, Shanghai (CN); Bharath SAKINALA, Hyderabad (IN); Praveen PERURU, Hyderabad (IN)

(21) Appl. No.: 16/078,794

(22) PCT Filed: Apr. 1, 2016
(86) PCT No.: PCT/CN2016/078360

§ 371 Date: Aug. 22, 2018

(51) Int. Cl. H04W 72/12; H04W 72/14; H04L 1/18; H04L 5/00; H04W 76/28; H04W 28/02; H04W 8/18; H04W 88/06

(52) U.S. Cl. CPC H04W 72/1215; H04W 72/1284; H04W 72/14; H04L 1/1812; H04W 88/06; H04W 76/28; H04W 28/0278; H04W 8/183; H04L 5/0055

(57) ABSTRACT

Various embodiments for managing uplink transmissions in a mobile communication device may include receiving, on a first subscription of the mobile communication device, an uplink grant from a first network and determining whether a tune-away from the first subscription to a second subscription of the mobile communication device is scheduled to occur during reception of a response message sent from the first network following an initial transmission of a data packet according to the uplink grant. The mobile communication device may use a block error rate and a buffer status report index of a connection between the first subscription and the first network to determine how to manage uplink transmissions following the tune-away.

### BACKGROUND

Some designs of wireless communication devices—such as smart phones, tablet computers, and laptop computers—contain one or more Subscriber Identity Module (SIM) cards that provide users with access to multiple separate mobile telephony networks. Examples of mobile telephony networks include Third Generation (3G), Fourth Generation (4G), Long Term Evolution (LTE), Time Division Multiple Access (TDMA), Frequency Division Multiple Access (FDMA), Code Division Multiple Access (CDMA), Wideband CDMA (WCDMA), Time Division Synchronous CDMA (TD-SCDMA), Global System for Mobile Communications (GSM), Universal Mobile Telecommunications Systems (UMTS), evolved High Speed Packet Access (HSPA+), Dual-Cell High Speed Packet Access (DC-HSPA), Evolution Data-Optimized (EV-DO), Enhanced Data rates for GSM Evolution (EDGE), and single carrier Radio Transmission Technologies (1×RTT).

A wireless communication device that includes one or more SIMs and connects to two or more separate mobile telephony networks using a shared radio frequency (RF) resource/radio may be termed a multi-SIM multi-standby (MSMS) communication device. One example of an MSMS communication device is a dual-SIM dual standby (DSDS) communication device, which includes two SIM cards supporting two subscriptions associated with different radio access technologies (RAT) sharing one RF resource. In DSDS communication devices, the separate subscriptions share the one RF resource to communicate with two separate mobile telephony networks on behalf of their respective subscriptions. When one RAT is using the RF resource, the other RAT is in stand-by mode and is not able to communicate using the RF resource.

### SUMMARY

Various embodiments include methods implemented on a mobile communication device for managing uplink transmissions in a mobile communication device. Various embodiments may include receiving, on a first subscription of the mobile communication device, an uplink grant from a first network, determining whether a tune-away from the first subscription to a second subscription of the mobile communication device is scheduled to occur during reception of a response message sent from the first network following an initial transmission of a data packet according to the uplink grant, and using a block error rate and a buffer status report index of a connection between the first subscription and the first network to determine how to manage uplink transmissions following the tune-away.

In some embodiments, using the block error rate and the buffer status report index of the connection between the first subscription and the first network to determine how to manage uplink transmissions following the tune-away may include comparing the block error rate to a first threshold in response to determining that the tune-away is scheduled to occur during reception of the response message, comparing the buffer status report index to a second threshold, and operating as if the response message transmitted during the tune-away was an acknowledgement when the block error rate is less than the first threshold and the buffer status report index is equal to or greater than the second threshold.

Some embodiments may further include blanking a next transmission to the first network following the tune-away, determining whether the first network sends a non-acknowledgement response message after blanking the next transmission, and waiting for additional control instructions from the first network in response to determining that the first network did not send a non-acknowledgement response message after blanking the next transmission. Some embodiments may further include resuming transmission based on the uplink grant in response to determining that the first network sent a non-acknowledgement response message after blanking the next transmission.

Some embodiments may further include operating as if the response message transmitted during the tune-away was a non-acknowledgement when the block error rate is equal to or greater than the first threshold or the buffer status report index is less than the second threshold, and retransmitting the data packet based on the uplink grant.

Some embodiments may further include determining values for the first threshold and the second threshold based on whether the first network is utilizing adaptive hybrid automatic repeat request (HARQ) and discontinuous transmission (DTX) for uplink communications. In some embodiments, determining values for the first threshold and the second threshold may include receiving, on the first subscription, an initial uplink grant from the first network, blanking a first transmission in response to receiving the initial uplink grant, determining whether the first network retransmits the initial uplink grant after blanking the first transmission, selecting a first value for the first threshold and a third value for the second threshold in response to determining that the first network retransmits the initial uplink grant, and selecting a second value for the first threshold and a fourth value for the second threshold in response to determining that the first network does not retransmit the initial uplink grant. In some embodiments, the second value may be less than the first value, and the fourth value may be less than the third value.

Some embodiments may further include determining whether the tune-away is scheduled to occur during the initial transmission of the data packet according to the uplink grant, and pausing building of the data packet in response to determining that the tune-away is scheduled to occur during the initial transmission of the data packet. Some embodiments may further include receiving, on the first subscription, the response message from the first network after the tune-away is complete, and transmitting the data packet based on the response message. The response message may include a new uplink grant.

Further embodiments include a mobile communication device including a memory and a processor configured with processor-executable instructions to perform operations of the methods described herein. Further embodiments include a non-transitory processor-readable storage medium having stored thereon processor-executable software instructions configured to cause a processor of a mobile communication device to perform operations of the methods described herein. Further embodiments include a mobile communication device that includes means for performing functions of the operations of the methods described herein.

### BRIEF DESCRIPTION OF THE DRAWINGS

The accompanying drawings, which are incorporated herein and constitute part of this specification, illustrate embodiments, and together with the general description and the detailed description given herein, serve to explain the features of the disclosed systems and methods.

FIG. 1 is a communication system block diagram of mobile telephony networks suitable for use with various embodiments.

FIG. 2 is a component block diagram of a multi-SIM mobile communication device according to various embodiments.

FIGS. 3A and 3B are call flow diagrams illustrating uplink transmission procedures between a mobile communication device and a network according to conventional methods.

FIG. 4 is a call flow diagram illustrating uplink transmission procedures between a mobile communication device and a network in the presence of a tune-away according to various embodiments.

FIG. 5 is a call flow diagram illustrating uplink transmission procedures between a mobile communication device and a network in the presence of a tune-away according to various embodiments.

FIGS. 6A and 6B are process flow diagrams illustrating methods for managing uplink transmissions in a mobile communication device according to various embodiments.

FIG. 7 is a process flow diagram illustrating a method for treating missed response messages on a mobile communication device as an acknowledgement according to various embodiments.

FIG. 8 is a process flow diagram illustrating a method for determining threshold values for use in treating missed response messages on a mobile communication device as an acknowledgement according to various embodiments.

FIG. 9 is a component block diagram of a mobile communication device suitable for implementing some embodiment methods.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the written description or the claims.

As used herein, the term “mobile communication device,” “multi-SIM mobile communication device,” or “multi-SIM device” refers to any one or all of cellular telephones, smart phones, personal or mobile multi-media players, personal data assistants, laptop computers, tablet computers, smart books, smart watches, palm-top computers, wireless electronic mail receivers, multimedia Internet-enabled cellular telephones, wireless gaming controllers, and similar personal electronic devices that includes one or more SIM cards, a programmable processor, memory, and circuitry for connecting to at least two mobile communication network with one or more shared RF resources. Various embodiments may be useful in mobile communication devices, such as smart phones, and so such devices are referred to in the descriptions of various embodiments. However, the embodiments may be useful in any electronic devices that may individually maintain a plurality of subscriptions that utilize at least one shared RF chain, which may include one or more of antennae, radios, transceivers, etc.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a mobile communication device on a network and enable a communication service with the network. Because the information stored in a SIM enables the mobile communication device to establish a communication link for a particular communication service with a particular network, the term “subscription” is used herein as a shorthand reference to refer to the communication service associated with and enabled by the information stored in a particular SIM as the SIM and the communication network, as well as the services and subscriptions supported by that network, correlate to one another.

In the following descriptions of various embodiments, references are made to a first subscription and a second subscription. The references to the first and second subscriptions are arbitrary and are used merely for the purposes of describing the embodiments. The device processor may assign any indicator, name or other designation to differentiate the subscriptions on the mobile communication device.

One consequence of having a plurality of RATs that maintain network connections simultaneously using a shared RF resource of a MSMS communication device is that one RAT sometimes interrupts each other's communications as only one RAT may use the shared RF resource to communicate with its mobile network at a time. Even when a RAT is in an “idle-standby” mode, meaning that the RAT is not actively communicating with the network, the RAT still needs to periodically receive access to the shared RF resource in order to perform various network operations. For example, an idle RAT may need the shared RF resource at regular intervals to perform idle-mode operations or to receive paging messages.

In conventional multi-SIM communication devices, an idle RAT may occasionally interrupt the active RAT's RF operations so that the idle RAT may use the shared RF resource to perform the idle RAT's idle-standby mode operations (e.g., paging monitoring and decoding, cell reselection, system information monitoring, etc.). This process of switching access of the shared RF resource from the active RAT to the idle RAT is sometimes referred to as a “tune-away,” as the RF resource tunes away from the active RAT's frequency band or channel and tune to the idle RAT's frequency bands or channels. After the idle RAT has finished its network communications, access to the RF resource may switch from the idle RAT to the active RAT via a “tune-back” operation.

A MSMS mobile communication device may have a first subscription (e.g., a LTE subscription) that performs uplink transmissions according to a hybrid automatic repeat request (HARQ). The uplink transmission process may start when a network associated with the first subscription transmits an uplink grant to the first subscription, for example through a physical downlink control channel (PDCCH). In response to the uplink grant, the first subscription may build and transmit a data packet to the network according to the uplink grant. For example, the transmission may occur during certain uplink subframes as specified by the uplink grant and the data packet may be sent through a physical uplink shared channel (PUSCH).

When the network receives the transmission, the network may send a response message to the first subscription through a physical HARQ indicator channel (PHICH). The response message may include an acknowledgement (ACK) if the network was able to receive and decode the transmission, or a non-acknowledgement (NAK) if the network was not able to receive or decode the transmission. The ACK/NAK may be sent over a physical HARQ indicator channel (PHICH).

The response message may also include a new uplink grant that signifies that the HARQ process should restart. The new uplink grant may include toggling a new data indicator (NDI) bit, which indicates that the HARQ buffer on the first subscription and the network should be cleared. If the NDI bit is not toggled, the existing HARQ buffer may be reused. The first subscription may then transmit another data packet based on the response message. For example, if the response message includes a NAK, the first subscription may re-transmit the data packet in the same format as before. If the response message includes a new uplink grant with the NDI bit toggled, the first subscription may clear the HARQ buffer and restart the HARQ transmission process. If the response message includes a new uplink grant with the NDI bit not toggled, the first subscription may not clear the HARQ buffer but simply restart the HARQ transmission process based to the old uplink grant.

The MSMS mobile communication device may support communications for a second subscription (e.g., GSM, CDMA). The mobile communication device may periodically perform a tune-away from the first subscription to the second subscription so that the second subscription can check for paging messages and/or perform other idle mode operations. However, issues may arise when the tune-away occurs during the uplink transmission process of the first subscription. For example, if the tune-away occurs when the network transmits a response message, the first subscription may not receive signals from the network that would inform the first subscription about whether the network successfully received/decoded the transmission, and whether a new uplink grant was sent. This may lead to a HARQ-level mismatch because in subsequent transmissions the first subscription and the network may be on different redundancy versions within the HARQ process.

In overview, various embodiments provide systems and methods implemented with a processor of a mobile communication device (e.g., a multi-SIM mobile communication device) for handling uplink transmissions when tune-aways are being performed. The processor may determine whether a tune-away from a first subscription to a second subscription of the mobile communication device is scheduled to occur when the first subscription is scheduled to transmit a data packet to its respective network base station in a HARQ process. If the tune-away occurs during the transmission, the mobile device may pause building the data packet during the tune-away and wait for the network to respond with a NAK, and in some cases a new uplink grant. The mobile device may then transmit the data packet based on the response message from the network (e.g., using the old or new uplink grant).

If the processor determines that the tune-away does not occur during the transmission, the processor may also determine whether the tune-away occurs during reception of a transmission response message from the network. If the tune-away occurs when the network is sending its response message (e.g., ACK/NAK and in some cases a new uplink grant), the processor may use a block error rate (BLER) and a buffer status report (BSR) index of a connection between the first subscription and the first network to determine how to manage uplink transmissions following the tune-away. The processor may determine how to manage uplink transmissions following the tune-away by comparing the BLER and BSR index of the connection to respective decision criteria, such as threshold conditions.

For example, the processor may determine how to manage uplink transmissions following the tune-away by comparing the BLER and the BSR index of the connection between the first subscription and the network to respective thresholds (i.e., a BLER threshold and a BSR threshold) or threshold conditions. For example, if the BLER satisfies a BLER threshold condition, such as the BLER is less than a certain (“first”) threshold (e.g., <10% error rate), and the BSR index satisfies a BSR threshold condition, such as the BSR is equal to or greater than a certain (“second”) threshold (e.g., BSR index over 50), the processor may treat the missed network response message as an ACK. Similarly, if the BLER does not satisfy the BLER threshold condition, such as the BLER is equal to or greater than the first (i.e., BLER) threshold or the BSR index does not satisfy the BSR threshold condition, such as the BSR index is less than the second (i.e., BSR) threshold, the processor may treat the missed network response message as an NAK. These example BLER and BSR threshold conditions and responses may enable the mobile communication device to operate as if the network successfully decoded the initial transmission under good radio conditions (e.g., low BLER, high BSR index) but retransmit under bad radio conditions. The value of the BLER and BSR thresholds may depend on whether the network is utilizing adaptive HARQ and discontinuous transmission (DTX) on the uplink communications.

For ease of reference, descriptions of various embodiments and the claims use the word “threshold” to refer generally to decision criterial and threshold conditions related to BLER and BSR index values. References to threshold conditions that are “greater than or equal to” a threshold are intended to encompass “greater than” conditions and threshold conditions that are “less than” a threshold are intended to encompass “equal to or less than” conditions because the threshold value may be adjusted accordingly. Further, references to “greater than or equal to” and “less than” threshold conditions are illustrative examples because equivalent conditions may be implemented with opposite sign conditions by adding or subtracting a constant from a threshold value or similar mathematical manipulations.

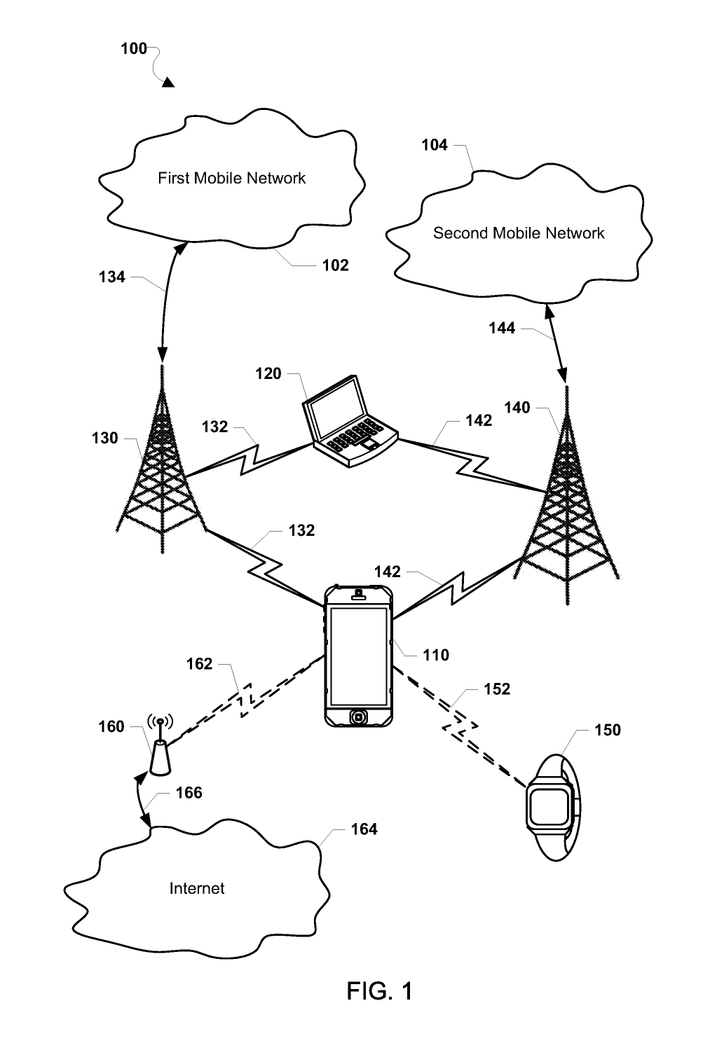

Various embodiments may be implemented within a variety of communication systems 100, such as at least two mobile telephony networks, an example of which is illustrated in FIG. 1. A first mobile network 102 and a second mobile network 104 typically each include a plurality of cellular base stations (e.g., a first base station 130 and a second base station 140). A first mobile communication device 110 may be in communication with the first mobile network 102 through a cellular connection 132 to the first base station 130. The first mobile communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second mobile communication device 120 may similarly communicate with the first mobile network 102 through the cellular connection 132 to the first base station 130. The second mobile communication device 120 may also communicate with the second mobile network 104 through the cellular connection 142 to the second base station 140. The cellular connections 132 and 142 may be made through two-way wireless communication links, such as Third Generation (3G), Fourth Generation (4G), Long Term Evolution (LTE), Time Division Multiple Access (TDMA), Code Division Multiple Access (CDMA), Wideband CDMA (WCDMA), Global System for Mobile Communications (GSM), Universal Mobile Telecommunications Systems (UMTS), and other mobile telephony communication technologies.

While the mobile communication devices 110, 120 are shown connected to the first mobile network 102 and, optionally, to the second mobile network 104, in some embodiments (not shown), the mobile communication devices 110, 120 may include two or more subscriptions to two or more mobile networks and may connect to those subscriptions in a manner similar to those described herein.

In some embodiments, the first mobile communication device 110 may optionally establish a wireless connection 152 with a peripheral device 150 used in connection with the first mobile communication device 110. For example, the first mobile communication device 110 may communicate over a Bluetooth® link with a Bluetooth-enabled personal computing device (e.g., a “smart watch”). In some embodiments, the first mobile communication device 110 may optionally establish a wireless connection 162 with a wireless access point 160, such as over a Wi-Fi connection. The wireless access point 160 may be configured to connect to the Internet 164 or another network over a wired connection 166.

While not illustrated, the second mobile communication device 120 may similarly be configured to connect with the peripheral device 150 and/or the wireless access point 160 over wireless links.

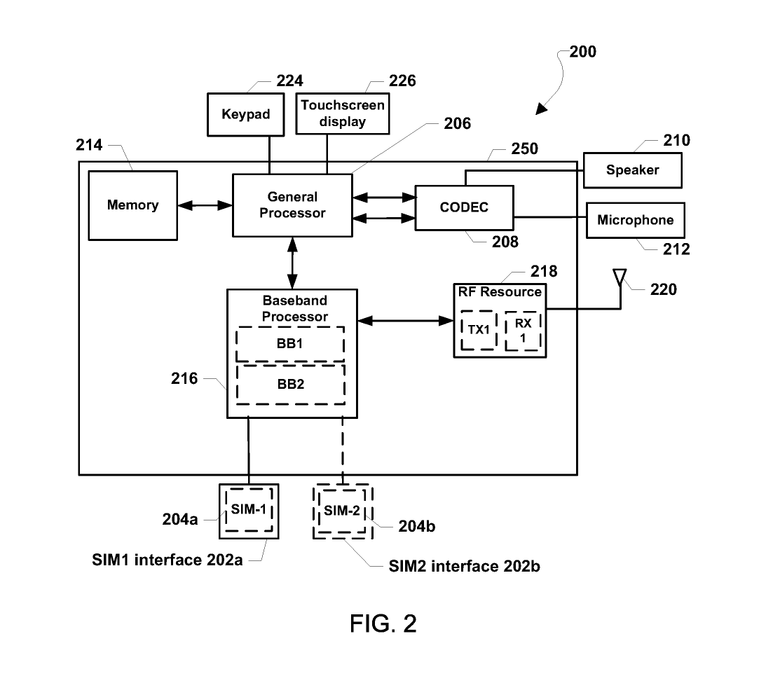

FIG. 2 is a functional block diagram of a multi-SIM mobile communication device 200 suitable for implementing various embodiments. With reference to FIGS. 1-2, the multi-SIM mobile communication device 200 may be similar to one or more of the mobile communication devices 110, 120 as described. The multi-SIM mobile communication device 200 may include a first SIM interface 202a, which may receive a first identity module SIM-1 204a that is associated with a first subscription. The multi-SIM mobile communication device 200 may also optionally include a second SIM interface 202b, which may receive an optional second identity module SIM-2 204b that is associated with a second subscription.

A SIM in various embodiments may be a Universal Integrated Circuit Card (UICC) that is configured with SIM and/or Universal SIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a central processing unit (CPU), read only memory (ROM), random access memory (RAM), electrically erasable programmable read only memory (EEPROM) and input/out (I/O) circuits.

A SIM used in various embodiments may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home Public Land Mobile Number (HPLMN) code, etc.) to indicate the SIM card network operator provider. An Integrated Circuit Card Identity (ICCID) SIM serial number may be printed on the SIM card for identification. However, a SIM may be implemented within a portion of memory of the multi-SIM mobile communication device 200 (e.g., in a memory 214), and thus need not be a separate or removable circuit, chip or card.

The multi-SIM mobile communication device 200 may include at least one controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer-readable storage medium that stores processor-executable instructions. For example, the instructions may include routing communication data relating to the first or second subscription though a corresponding baseband-RF resource chain.

The memory 214 may store an operating system (OS), as well as user application software and executable instructions. The memory 214 may also store application data and may store exclude lists for RATs on the multi-SIM mobile communication device 200.

The general processor 206 and the memory 214 may each be coupled to at least one baseband modem processor 216. Each SIM and/or RAT in the multi-SIM mobile communication device 200 (e.g., the SIM-1 204a and/or the SIM-2 204b) may be associated with a baseband-RF resource chain. A baseband-RF resource chain may include the baseband modem processor 216, which may perform baseband/modem functions for communications with/controlling a RAT, and may include one or more amplifiers and radios, referred to generally herein as RF resources (e.g., RF resource 218). In some embodiments, baseband-RF resource chains may share the baseband modem processor 216 (i.e., a single device that performs baseband/modem functions for all RATs on the multi-SIM mobile communication device 200). In other embodiments, each baseband-RF resource chain may include physically or logically separate baseband processors (e.g., BB1, BB2).

The RF resource 218 may be a transceiver that performs transmit/receive functions for each of the SIMs/RATs on the multi-SIM mobile communication device 200. The RF resource 218 may include separate transmit and receive circuitry, or may include a transceiver that combines transmitter and receiver functions. In some embodiments, the RF resource 218 may include multiple receive circuitries. The RF resource 218 may be coupled to a wireless antenna (e.g., a wireless antenna 220). The RF resource 218 may also be coupled to the baseband modem processor 216.

In some embodiments, the general processor 206, the memory 214, the baseband processor(s) 216, and the RF resource 218 may be included in the multi-SIM mobile communication device 200 as a system-on-chip 250. In some embodiments, the first and second SIMs 204a, 204b and the corresponding interfaces 202a, 202b may be external to the system-on-chip 250.

Various input and output devices may be coupled to components on the system-on-chip 250, such as interfaces or controllers. Example user input components suitable for use in the multi-SIM mobile communication device 200 may include, but are not limited to, a keypad 224, a touchscreen display 226, and the microphone 212. In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software modules and functions in the multi-SIM mobile communication device 200 to enable communication between them, as is known in the art.

Functioning together, the two SIMs 204a, 204b, the baseband processor BB1, BB2, the RF resource 218, and the wireless antenna 220 may constitute two or more radio access technologies (RATs). For example, the multi-SIM mobile communication device 200 may be a LTE communication device that includes a SIM, baseband processor, and RF resource configured to support two different RATs, such as LTE, WCDMA, and GSM. More RATs may be supported on the multi-SIM mobile communication device 200 by adding more SIM cards, SIM interfaces, RF resources, and antennae for connecting to additional mobile networks.

In some embodiments (not shown), the multi-SIM mobile communication device 200 may include, among other things, additional SIM cards, SIM interfaces, a plurality of RF resources associated with the additional SIM cards, and additional antennae for supporting subscriptions communications with additional mobile networks.

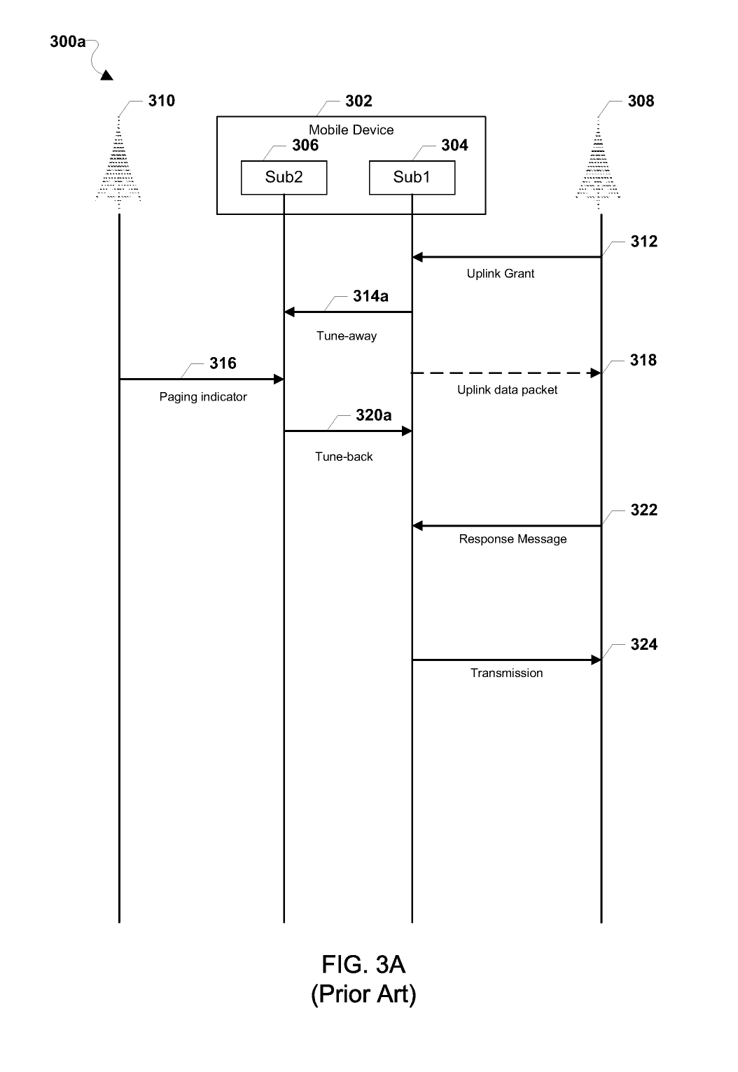

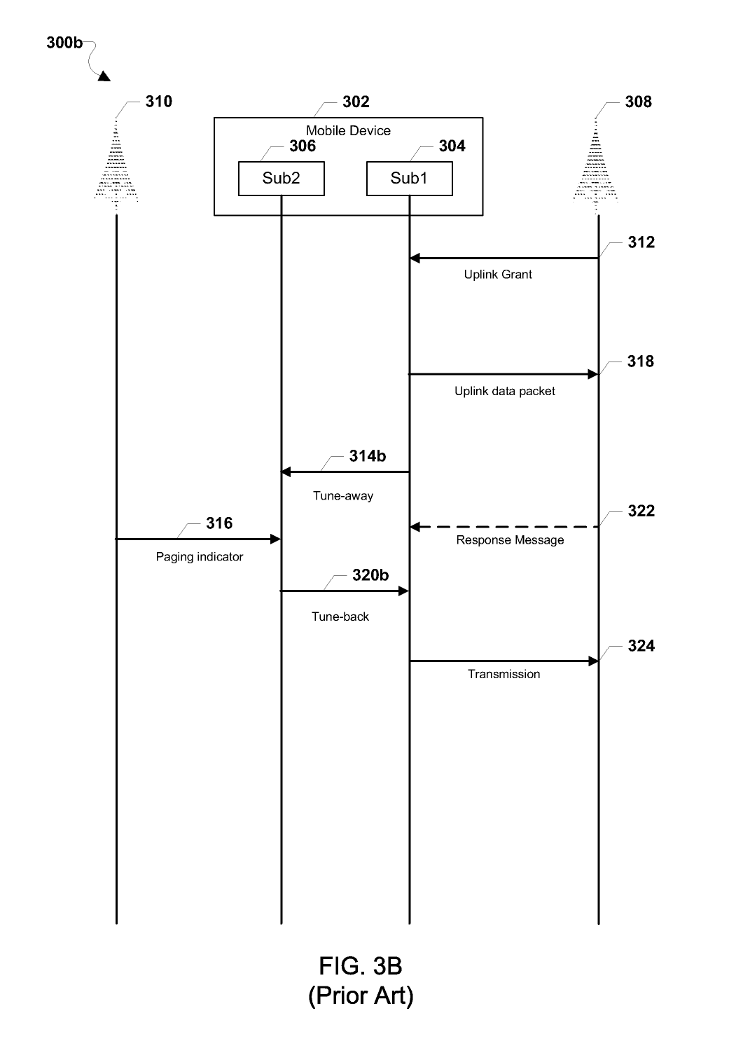

FIGS. 3A and 3B illustrate conventional call flows and message exchanges during an uplink HARQ transmission process on a multi-SIM multi-standby mobile communication device in the presence of tune-aways. FIG. 3A includes a call flow diagram 300a that illustrates when a tune-away occurs during initial transmission by a subscription, while FIG. 3B includes a call flow diagram 300b that illustrates when a tune-away occurs during reception of a transmission response message from a network.

With reference to FIGS. 1-3A, the diagram 300a includes a mobile communication device 302 having a first subscription 304 and a second subscription 306. The mobile communication device 302 may be a MSMS mobile communication device, such as a DSDS mobile communication device. The first subscription 304 and the second subscription 306 may utilize a shared RF resource on the mobile communication device 302. The first subscription 304 communicates with a first network 308, while the second subscription 306 communicates with a second network 310.

The first network 308 may transmit an uplink grant 312 to the first subscription 304 through the PDCCH. The uplink grant 312 may be used to initiate a HARQ transmission process between the first subscription 304 and the first network 308. The uplink grant 312 may specify the subframes in which the first subscription 304 should transmit data packets to the first network 308, the transport block size, the state of the NDI bit, and other information.

The mobile communication device 302 may be configured to periodically perform tune-aways from the first subscription 304 to the second subscription 306. The tune-away may be scheduled to occur when the first subscription 304 is scheduled to transmit an uplink data packet 318 following the uplink grant 312. For example, after the first subscription 304 receives the uplink grant 312, the mobile communication device 302 may perform a tune-away 314a from the first subscription 304 to the second subscription 306. The second subscription 306 may communicate with the second network 310 to receive a paging indicator 316 that indicates whether there is an incoming paging message for the second subscription. If there is no paging message, the mobile communication device 302 may perform a tune-back 320a from the second subscription 306 to the first subscription 304. However, between the tune-away 314a and the tune-back 320a, the first subscription 304 was not able to transmit the uplink data packet 318.

The first network 308 may be expecting the uplink data packet 318, and when the first network 308 does not receive any packets at the scheduled subframe, the first network 308 may transmit a response message 322. The response message 322 may include a NAK indicating that the first network 308 did not receive and/or decode the uplink data packet 318. The response message 322 may also include a new uplink grant. The response message 322 may be sent through a PHICH.

Upon receipt of the response message 322, the first subscription 304 may perform a transmission 324 based on the response message 322. For example, if the response message 322 includes a new uplink grant with the NDI bit toggled, the first subscription 304 may clear its HARQ buffer and restart the transmission process based on the new uplink grant. If the response message does not include a new uplink grant, the first subscription 304 may retransmit the data packet based on the old uplink grant (i.e., continue on the current HARQ process).

With reference to FIGS. 1-3B, the diagram 300b illustrates communications of the mobile communication device 302 having the first subscription 304 and the second subscription 306 communicating with respective networks. The first network 308 may transmit the uplink grant 312 to the first subscription 304 through the PDCCH. The uplink grant 312 may be used to initiate a HARQ transmission process between the first subscription 304 and the first network 308. The uplink grant 312 may specify the subframes in which the first subscription 304 should transmit data packets to the first network 308, the transport block size, the state of the NDI bit, and other information.

In response to the uplink grant 312, the first subscription may build and transmit the uplink data packet 318 according to the uplink grant 312. After the first subscription 304 transmits the uplink data packet 318, the mobile communication device 302 may perform a tune-away 314b from the first subscription 304 to the second subscription 306. The second subscription 306 may communicate with the second network 310 to receive a paging indicator 316 that indicates whether there is an incoming paging message for the second subscription. If there is no paging message, then the mobile communication device 302 may perform a tune-back 320b from the second subscription 306 to the first subscription 304. However, between the tune-away 314b and the tune-back 320b, the first subscription 304 did not receive the response message 322 sent from the first network 308. Thus, the first subscription 304 does not receive either an ACK or a NAK response message 322 from the first network, nor does the first subscription 304 receive a new uplink grant if that was provided by the network.

The first subscription 304 may be configured to automatically treat missed response messages as a NAK, so the first subscription 304 may retransmit the uplink data packet 318 in the transmission 324. However, if the response message 322 included a new uplink grant (either with or without a toggled NDI bit), there may be a mismatch in the HARQ redundancy version number used by the first subscription 304 and the first network 308. The transmission 324 may not be acknowledged by the first network 308 due to the mismatch (e.g., the first network 308 may not trigger discontinuous transmission procedures). The first subscription 304 may continue to attempt HARQ-level retransmissions until the maximum number of HARQ-level retransmissions has been reached. The first subscription 304 and the first network 308 may then completely restart the uplink transmission process. However, this process may impact the user experience by delaying communications and consuming more power while using more device resources.

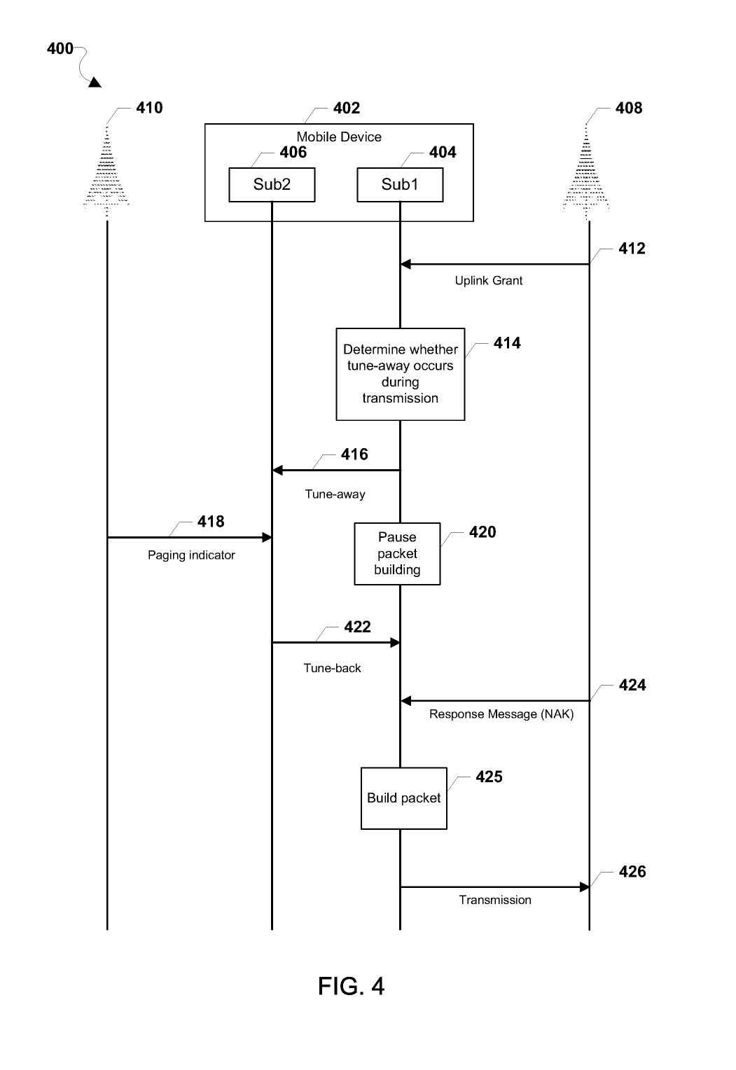

FIG. 4 illustrates call flows and message exchanges for managing uplink transmissions in a mobile communication device when tune-aways are occurring according to various embodiments. With reference to FIGS. 1-2 and 4, the diagram 400 illustrates communications of a mobile communication device 402 having a first subscription 404 (e.g., LTE) and a second subscription 406 (e.g., GSM or CDMA). The mobile communication device 402 may be a MSMS mobile communication device, such as a DSDS mobile communication device. The first subscription 404 and the second subscription 406 may utilize a shared RF resource on the mobile communication device 402. The first subscription 404 communicates with a first network 408, while the second subscription 406 communicates with a second network 410.

The first network 408 may transmit an uplink grant 412 to the first subscription 404 through the PDCCH. The uplink grant 412 may be used to initiate a HARQ transmission process between the first subscription 404 and the first network 408. The uplink grant 412 may specify the subframes in which the first subscription 404 should transmit data packets to the first network 408, the transport block size, the state of the NDI bit, and other information.

The mobile communication device 402 may be configured to periodically perform tune-aways from the first subscription 404 to the second subscription 406. The mobile communication device 402 may determine whether a tune-away is scheduled to occur during the initial data packet transmission following the uplink grant 412 in operation 414. If it is determined that the tune-away is scheduled to occur during the initial transmission of data, the mobile communication device 402 may be configured to pause uplink packet building in operation 420 after a tune-away 416 is initiated. During the tune-away 416, the second subscription 406 may check for a paging indicator 418 sent by the second network 410.

After the mobile communication device 402 performs a tune-back 422 to the first subscription 404, the first subscription 404 may receive a response message 424 from the first network 408. The response message 424 may include a NAK because the first subscription 404 did not transmit an uplink data packet during the scheduled transmission subframe. The response message 424 may also include a new uplink grant. The first subscription 404 may then restart packet building in operation 425 and send a transmission 426 based on the response message 424. For example, if the response message 424 includes a new uplink grant but the NDI bit is not toggled and the transport block size has not changed, the first subscription 404 may resume building and transmitting the data packet that was paused during the tune-away 416. If the transport block size has changed, or the NDI bit is toggled in the new uplink grant, the first subscription 404 may build a new packet for transmission, and the paused data packet may be retransmitted using a radio link control (RLC) retransmission process. This may allow the mobile communication device 402 to handle missed uplink transmissions due to the presence of tune-aways more efficiently.

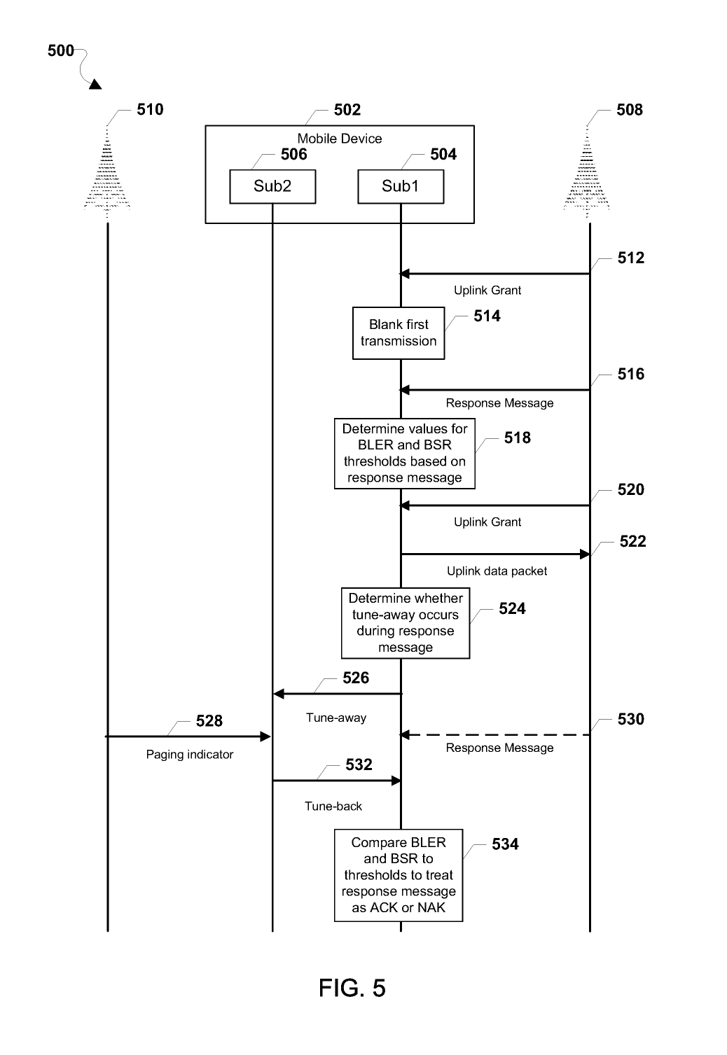

FIG. 5 illustrates another example of call flows and message exchanges for managing uplink transmissions in a mobile communication device tune-aways are occurring according to various embodiments. With reference to FIGS. 1-2 and 4-5, the diagram 500 illustrates communications of a mobile communication device 502 having a first subscription 504 (e.g., LTE) and a second subscription 506 (e.g., GSM or CDMA). The mobile communication device 502 may be a MSMS mobile communication device, such as a DSDS mobile communication device. The first subscription 504 and the second subscription 506 may utilize a shared RF resource on the mobile communication device 502. The first subscription 504 communicates with a first network 508, while the second subscription 506 communicates with a second network 510.

The first subscription 504 may connect to a base station of the first network 508. For example, the connection may be an initial service connection or may be a cell reselection from another base station of the first network 508. The first network 508 may transmit an initial uplink grant 512 to the first subscription 504. Instead of transmitting a data packet according to the initial uplink grant 512, the first subscription 504 may blank the first transmission in operation 514.

The first network 508 may then transmit a response message 516 in response the blanked transmission. The contents of the response message 516 may depend on whether the first network 508 is utilizing adaptive HARQ and DTX detection for uplink communications. For example, if the first network 508 is utilizing adaptive HARQ and DTX detection for uplink communications, the response message 516 may include a NAK and a retransmission of the uplink grant 512. If first network 508 is not utilizing adaptive HARQ or DTX detection for uplink communications, the response message 516 may include a NAK but no retransmission of the uplink grant 512.

The first subscription 504 may determine values for BLER and BSR thresholds based on the response message 516 in operation 518. If the first subscription 504 misses a future response message because of a tune-away to the second subscription 506, the first subscription 504 may treat the missed response message as an ACK or a NAK based on the BLER and BSR thresholds. If the first subscription 504 treats the missed response message as an ACK when it is really a NAK (a false positive), the first network 508 may respond differently depending on whether it is utilizing adaptive HARQ and DTX detection for uplink communications. For example, if the first network 508 is utilizing adaptive HARQ and DTX detection for uplink communications and re-transmits the uplink grant, the first subscription 504 may restart the HARQ transmission and so one transmission sub-frame is wasted. If the first network 508 is not utilizing adaptive HARQ or DTX detection for uplink communications and simply transmits a NAK, the first subscription 504 may continue on the current HARQ transmission and transmit up to the maximum number of HARQ attempts. Each of these attempts may fail there is a HARQ-level mismatch between the first subscription 504 and the first network 508.

Thus the time penalty for a false positive is greater when the first network 508 is not utilizing adaptive HARQ or DTX detection for uplink communications. The values for BLER and BSR thresholds may be then be selected to reduce the occurrence of false positives if the first network 508 is not utilizing adaptive HARQ or DTX detection for uplink communications. The BLER and BSR thresholds may have higher values if the first network 508 is utilizing adaptive HARQ and DTX detection for uplink communications, and may have lower values if the first network 508 is not utilizing adaptive HARQ or DTX detection for uplink communications. In a non-limiting example, the BLER threshold may be 10% if the first network 508 is utilizing adaptive HARQ and DTX detection for uplink communications and may be 2% if the first network 508 is not utilizing adaptive HARQ or DTX detection for uplink communications. Similarly, the BSR threshold may be 50 if the first network 508 is utilizing adaptive HARQ and DTX detection for uplink communications and may be 10 if the first network 508 is not utilizing adaptive HARQ or DTX detection for uplink communications.

At a later time, the first network 508 may transmit another uplink grant 520 to the first subscription 504 through the PDCCH. The uplink grant 520 may be used to initiate a HARQ transmission process between the first subscription 504 and the first network 508. The uplink grant 520 may specify the subframes in which the first subscription 504 should transmit data packets to the first network 508, the transport block size, the state of the NDI bit, and other information. The first subscription 504 may build and transmit an uplink data packet 522 to the first network 508 according to the uplink grant 520.

The mobile communication device 502 may be configured to periodically perform tune-aways from the first subscription 504 to the second subscription 506. For example, the mobile communication device 502 may perform a tune-away 526 to the second subscription 506 so that the second subscription may check a paging indicator 528 from the second network 510. The mobile communication device 502 may then perform a tune-back 532 to the first subscription 504.

The mobile communication device 502 may determine whether a tune-away is scheduled to occur during reception of a response message 530 from the first network 508 in operation 524. If a processor of the mobile communication device 502 that a tune-away is scheduled to occur during reception of the response message 530, the mobile communication device 502 may compare the BLER and the BSR index of the connection between the first subscription 504 and the first network 508 to the determined BLER threshold and BSR threshold, respectively, in operation 534. For example, the processor may compare the BLER to a first (i.e., BLER) threshold (e.g., 10%) and compare the BSR index to a second (i.e., BSR) threshold (e.g., a BSR index over 50). The BLER may be indicative of the likelihood that the first network 508 is able to decode any particular uplink transmission (i.e., a strong connection), with a lower BLER indicating a greater likelihood of successful decoding. The BSR index may be indicative of the likelihood that the first network 508 assigned a new uplink grant, with a higher BSR index indicating a higher likelihood that the first network 508 assigned a new uplink grant. The BLER and BSR index information may be maintained and periodically calculated by a processor of the mobile communication device 502.

If the BLER is less than the first threshold and the BSR index is equal to or greater than the second threshold, the first subscription 504 may treat the missed response message 530 as an ACK. In that case, the first subscription 504 may stop, or blank, the next uplink transmission. In other words, if the processor of the mobile communication device 502 determines that the connection between the first subscription 504 and the first network 508 is strong and that it is likely that the first network 508 sent a new uplink grant, the first subscription 504 may keep data in the HARQ buffer and blank the next transmission. The processor supporting the first subscription 504 may additionally determine whether a NAK is received from the first network 508 after blanking the next transmission. Reception by the first subscription 504 of a NAK may indicate that the issued response message 530 was actually a NAK even though the first subscription 504 treated the missed response message as if an ACK was received. If a NAK is received from the first network 508, the first subscription 504 may resume the HARQ transmission process based on the current uplink grant. If a NAK is not received from the first network 508, the first subscription 504 may wait for additional control instructions from the first network 508, such as a new uplink grant

If the BLER is equal to or greater than the first threshold and/or the BSR index is less than the second threshold, the first subscription 504 may treat the missed response message 530 as a NAK. In other words, if the connection between the first subscription 504 and the first network 508 is not strong or the BSR indicates that is the first network 508 probably did not send a new uplink grant, the first subscription 504 may treat the response message 530 as a NAK and re-transmit the data packet under the current uplink grant. Regardless of whether the response message 530 is actually an ACK or a NAK, the first network 508 may acknowledge the retransmission and so the HARQ redundancy versions are still matched.

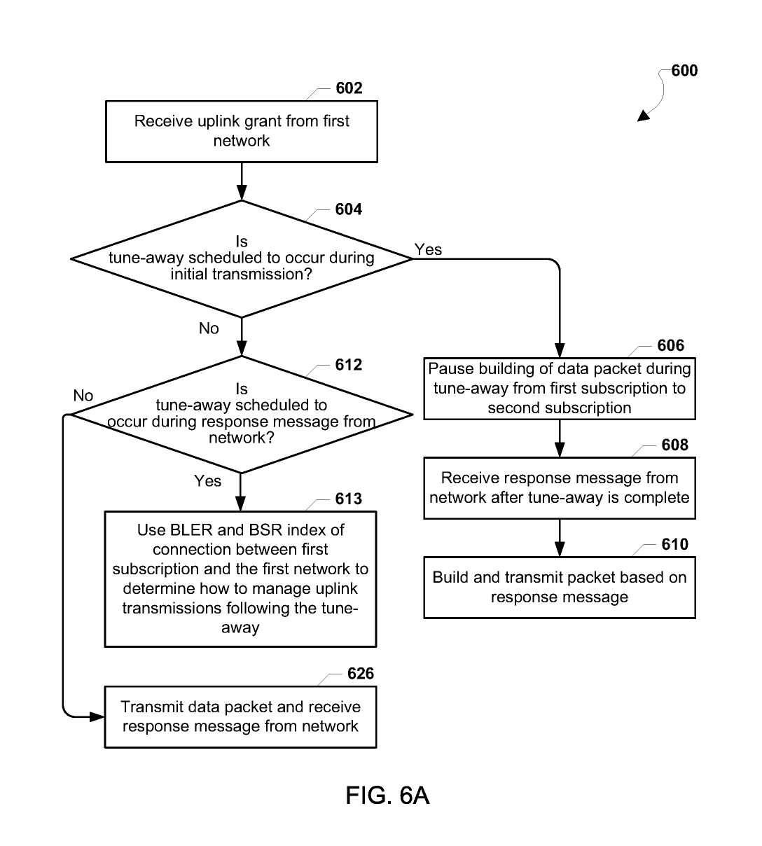

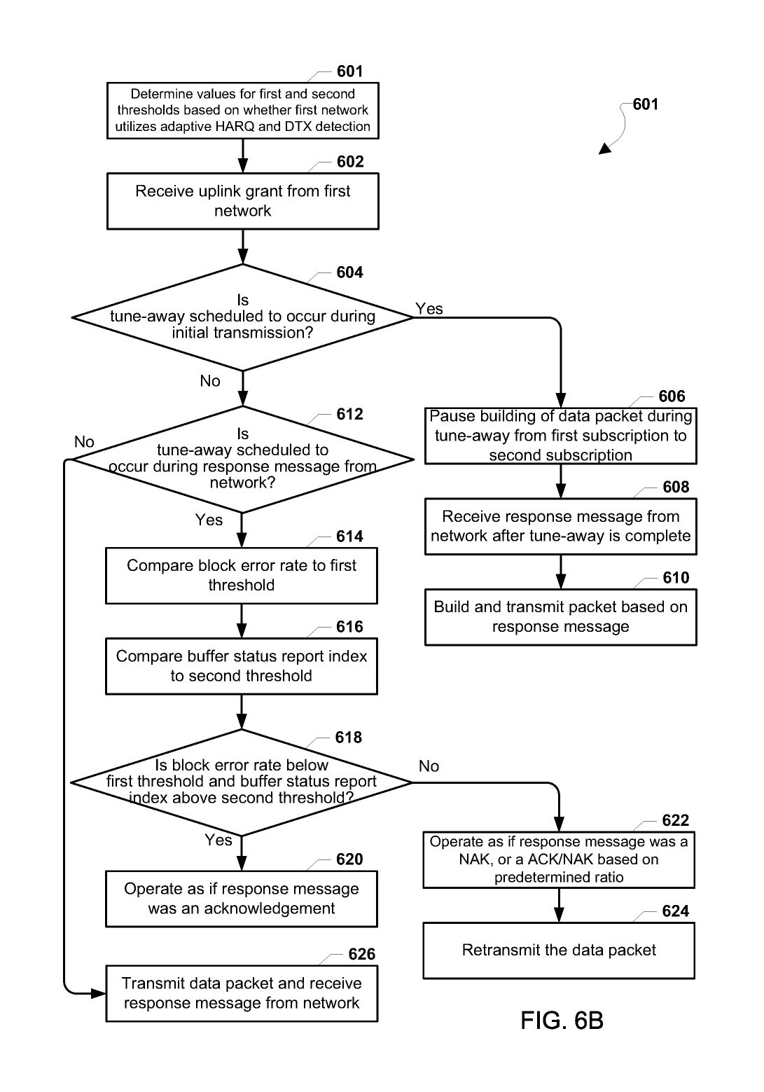

FIG. 6A illustrates a method 600 for managing uplink transmissions in a mobile communication device according to various embodiments. With reference to FIGS. 1-2 and 4-6A, the method 600 may be implemented with a processor (e.g., the general processor 206, the baseband modem processor 216, a separate controller, and/or the like) of a mobile communication device (such as the mobile communication devices 110, 120, 402, 502) that supports a first subscription (e.g., LTE) and a second subscription (e.g., GSM or CDMA) that share a RF resource.

In block 602, the processor may receive an uplink grant from a first network to the first subscription. The uplink grant may be used to establish a HARQ-level transmission process between the first network and the first subscription. For example, the uplink grant may specify the subframes in which the first subscription should transmit data to the first network, the transport block size, the state of the NDI bit, and other information. The uplink grant may be transmitted through a PDCCH.

In determination block 604, the processor may determine whether a tune-away from the first subscription to the second subscription is scheduled to occur during the initial transmission of a data packet after receiving the uplink grant.

In response to determining that the tune-away is scheduled to occur during the initial transmission of the data packet (i.e., determination block 604=“Yes”), the processor may pause the building of the data packet during the tune-away from the first subscription to the second subscription in block 606. In block 608, the processor may receive, on the first subscription, a response message sent by the first network after the tune-away is complete. The response message may include a NAK because no transmission occurred, and may also include a new uplink grant.

In block 610, the processor may build and transmit the data packet on the first subscription based on the response message. For example, if the response message includes a new uplink grant but the NDI bit is not toggled and the transport block size has not changed, the first subscription may resume building and transmitting the current data packet that was paused during the tune-away. If the transport block size has changed, or the NDI bit is toggled in the new uplink grant, the first subscription may build a new packet for transmission, and the paused data packet may be retransmitted using a RLC retransmission process.

In response to determining that the tune-away is not scheduled to occur during the initial transmission of the data packet (i.e., determination block 604=“No”), the processor may determine whether the tune-away is scheduled to occur during reception of the response message from the first network in determination block 612. In other words, the processor may determine whether the tune-away occurs after the first subscription transmits the first data packet and is expecting a response message from the first network.

In response to determining that the tune-away is scheduled to occur during reception of the response message from the first network (i.e., determination block 612=“Yes”), the processor may use a block error rate and a buffer status report index of a connection between the first subscription and the first network to determine how to manage uplink transmissions following the tune-away in block 613. An example of operations that may be performed to make this determination are described with reference to FIG. 6B.

In response to determining that the tune-away is not scheduled to occur during reception of the response message from the first network (i.e., determination block 612=“No”), the processor may transmit the initial data packet and receive the response message from the first network in block 626.

FIG. 6B illustrates a method 601 for managing uplink transmissions in a mobile communication device according to various embodiments. With reference to FIGS. 1-2 and 4-6B, the method 601 may be implemented with a processor (e.g., the general processor 206, the baseband modem processor 216, a separate controller, and/or the like) of a mobile communication device (such as the mobile communication devices 110, 120, 402, 502) that supports a first subscription (e.g., LTE) and a second subscription (e.g., GSM or CDMA) that share a RF resource.

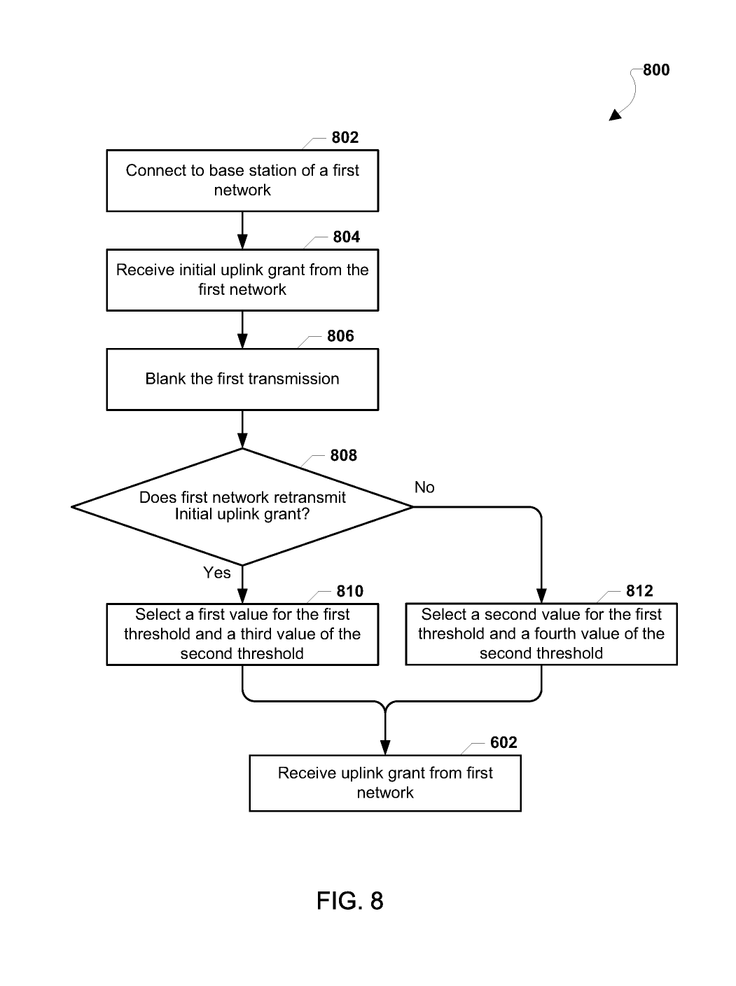

In block 601, the processor may determine values for a first threshold and a second threshold based on whether the first network is utilizing adaptive HARQ and DTX detection for uplink communications. The first and second thresholds may be used to determine whether the first subscription treats a missed response message from the first network as an ACK or a NAK. For example, the first threshold may be compared to a BLER value of the first subscription and the second threshold may be compared to a BSR index of the first subscription in response to a missed response message. Additional details for determining the values for the first and second thresholds are described with reference to method 800 in FIG. 8.

In blocks 602-610, the processor may perform operations of like numbered blocks of the method 600 as described with reference to FIG. 6A. For example, in block 602 the processor may receive an uplink grant from a first network to the first subscription. The uplink grant may be used to establish a HARQ-level transmission process between the first network and the first subscription. For example, the uplink grant may specify the subframes in which the first subscription should transmit data to the first network, the transport block size, the state of the NDI bit, and other information. The uplink grant may be transmitted through a PDCCH.

In determination block 604, the processor may determine whether a tune-away from the first subscription to the second subscription is scheduled to occur during the initial transmission of a data packet after receiving the uplink grant.

In response to determining that the tune-away is scheduled to occur during the initial transmission of the data packet (i.e., determination block 604=“Yes”), the processor may pause the building of the data packet during the tune-away from the first subscription to the second subscription in block 606. In block 608, the processor may receive, on the first subscription, a response message sent by the first network after the tune-away is complete. The response message may include a NAK because no transmission occurred, and may also include a new uplink grant.

In block 610, the processor may build and transmit the data packet on the first subscription based on the response message. For example, if the response message includes a new uplink grant but the NDI bit is not toggled and the transport block size has not changed, the first subscription may resume building and transmitting the current data packet that was paused during the tune-away. If the transport block size has changed, or the NDI bit is toggled in the new uplink grant, the first subscription may build a new packet for transmission, and the paused data packet may be retransmitted using a RLC retransmission process.

In response to determining that the tune-away is not scheduled to occur during the initial transmission of the data packet (i.e., determination block 604=“No”), the processor may determine whether the tune-away is scheduled to occur during reception of the response message from the first network in determination block 612. In other words, the processor may determine whether the tune-away occurs after the first subscription transmits the first data packet and is expecting a response message from the first network.

In response to determining that the tune-away is not scheduled to occur during reception of the response message from the first network (i.e., determination block 612=“No”), the processor may transmit the initial data packet and receive the response message from the first network in block 626.

In response to determining that the tune-away is scheduled to occur during reception of the response message from the first network (i.e., determination block 612=“Yes”), the processor may compare a block error rate (BLER) of the connection between the first subscription and the first network to the first threshold in block 614. This comparison may be done during or after the tune-away to the second subscription is complete. A low BLER may be indicative of a good connection between the first subscription and the first network. In some non-limiting examples the first threshold may be 5%, 10%, or 15%.

In block 616 the processor may compare a buffer status report (BSR) index of the first subscription to the second threshold. A high BSR index may be an indicator that the first network sent a new uplink grant. In some non-limiting examples the second threshold may be 40 or 50.

In determination block 618, the processor may determine whether the BLER is less than the first threshold and the BSR index is equal to or greater than the second threshold.

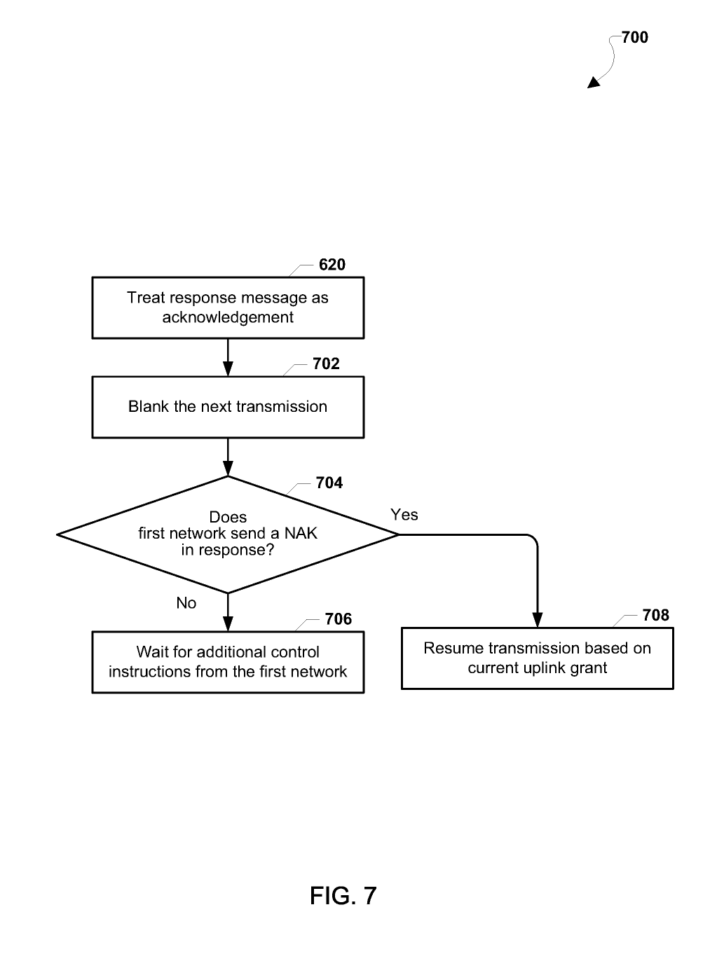

In response to determining that the BLER is less than the first threshold and the BSR index is equal to or greater than the second threshold (i.e., determination block 618=“Yes”), the processor may treat the missed response message from the first network as an acknowledgement, or ACK, in block 620. In other words, if the BLER and BSR index indicate a strong connection between the first subscription and the first network and that first network likely sent a new uplink grant, the processor may stop the next transmission and wait for additional control instructions from the first network. Additional operations when the processor treats the missed response message as an ACK are described with reference to method 700 in FIG. 7.

In response to determining that the BLER is not less than the first threshold or that the BSR index is not equal to or greater than the second threshold (i.e., determination block 618=“No”), the processor may treat the missed response message from the first network as a non-acknowledgement, or NAK, in block 622. In alternative embodiments, the processor may treat the missed response message as a NAK or an ACK based on a predetermined ratio (e.g., treat as a NAK 50% of the time, and as an ACK 50% of the time). The processor may then re-transmit the data packet based on the old uplink grant in block 624. In other words, if the BLER and BSR index indicate a weak connection between the first subscription and the first network or that it unlikely the first network sent a new uplink grant, the processor may re-transmit the data packet using the same uplink grant. In this manner, the method 600 allows for more efficient processing of uplink transmissions in the presence of tune-aways.

FIG. 7 illustrates a method 700 for a mobile communication device treating a missed response message from a network as an acknowledgement, as well as a fall back mechanism if the acknowledgment does not match the actual missed response message, according to various embodiments. With reference to FIGS. 1-2 and 4-7, the method 700 includes operations that may be performed after block 620 of the method 600, and may be implemented by a processor (e.g., the general processor 206, the baseband modem processor 216, a separate controller, and/or the like) of a mobile communication device (such as the mobile communication devices 110, 120, 402, 502) that supports a first subscription (e.g., LTE) and a second subscription (e.g., GSM or CDMA) that share a RF resource.

After the processor treats a missed response message from the first network as an acknowledgement, or ACK, in block 620, the processor may blank, or stop, the next transmission in block 702. In determination block 704, the processor may determine whether the first network sends a NAK after blanking the next transmission. In other words, the processor may test whether the missed response message is actually a NAK although it was treated as an ACK.

In response to determining that the first network does not send a NAK after blanking the next transmission (i.e., determination block 704=“No”), the processor may wait for additional control instructions from the first network in block 706. In other words, if the missed response message is actually an ACK and the processor operates as if an ACK was transmitted, the first network should not send a NAK after blanking the next transmission. Therefore, the processor may simply wait for further instructions. The additional control instructions may include, for example, a new uplink grant.

In response to determining that the first network sends a NAK after blanking the next transmission (i.e., determination block 704=“No”), the processor may resume transmission using the current uplink grant in block 708. In other words, if the missed response message is actually an NAK and the processor operates as if an ACK was transmitted, the first network may expect a retransmission and send a NAK when the next transmission is blanked. The processor may then resume the transmission based on the current uplink grant. In this manner, the method 700 provides additional corrective procedures when treating missed response messages as acknowledgements.

FIG. 8 illustrates a method 800 for determining threshold values for use in treating missed response messages on a mobile communication device as an acknowledgement according to various embodiments. With reference to FIGS. 1-2 and 4-8, the method 800 includes operations that may be performed during block 601 of the method 6001. The method 800 may be implemented with a processor (e.g., the general processor 206, the baseband modem processor 216, a separate controller, and/or the like) of a mobile communication device (such as the mobile communication devices 110, 120, 402, 502) that supports a first subscription (e.g., LTE) and a second subscription (e.g., GSM or CDMA) that share a RF resource. The first subscription may be associated with a first network. The mobile communication device may store a first threshold (i.e., a BLER threshold) and a second threshold (i.e., a BSR index threshold) that may be compared to the BLER and BSR index values of the first subscription. The comparison may determine whether the first subscription operates as if a missed response message from the first network is an ACK or a NAK.

In block 802, the processor may connect the first subscription to a base station of the first network. For example, the connection may be an initial service connection after the first subscription conducts a public land mobile network (PLMN) search for the first network. The connection may also be caused by cell reselection from another base station of the first network.

In block 804, the processor may receive an initial uplink grant from the first network. In some embodiments, the initial uplink grant may be the first uplink grant sent to the first subscription after connecting to the base station of the first network. The initial uplink grant may be used to establish a HARQ-level transmission process between the first network and the first subscription. For example, the initial uplink grant may specify the subframes in which the first subscription should transmit data to the first network, the transport block size, the state of the NDI bit, and other information. The initial uplink grant may be transmitted through a PDCCH.

In block 806, the processor may black the first transmission on the first subscription. Normally, the first subscription may transmit data packets according to the uplink grant. However, blanking the first transmission of packet data may be used to determine whether the first network is utilizing adaptive HARQ and DTX detection for uplink communications based on the reaction of the first network to the blanked transmission.

In determination block 808, the processor may determine whether the first network retransmits the initial uplink grant in response to the blanked transmission on the first subscription. If the first network retransmits the initial uplink grant, it is an indication that the first network is utilizing adaptive HARQ and DTX detection for uplink communications.

In response to determining that the first network retransmits the initial uplink grant (i.e., determination block 808=“Yes”), the processor may select a first value for the first threshold and a third value for the second threshold in block 810. In other words, upon determining that the first network is utilizing adaptive HARQ and DTX detection for uplink communications, the processor may select particular values for the first and second thresholds. In a non-limiting example, the first value for the first threshold (i.e., the BLER threshold) may be 10%, and the third value for the second threshold (i.e., the BSR index threshold) may be 50.

In response to determining that the first network retransmits the initial uplink grant (i.e., determination block 808=“No”), the processor may select a second value for the first threshold and a fourth value for the second threshold in block 812. In other words, upon determining that the first network is not utilizing adaptive HARQ or DTX detection for uplink communications, the processor may select particular values for the first and second thresholds. In a non-limiting example, the second value for the first threshold (i.e., the BLER threshold) may be 2%, and the fourth value for the second threshold (i.e., the BSR index threshold) may be 10.

The second value for the first threshold may be less than the first value utilized in block 810 (e.g., 10%>2%), and the fourth value for the second threshold may be less than the third value utilized in block 810 (e.g., 50>10). The second value for the first threshold and the fourth value for the second threshold selected in block 812 may reduce the incidence of false positives when the first subscription is determining whether a missed response message from the first network is an ACK or a NAK. In other words, the second value for the first threshold and the fourth value for the second threshold may be selected in block 812 so that the incidence of false positives (i.e., operating as if the missed response message is an ACK when it is really a NAK) is lower than if the first value for the first threshold and the third value for the second threshold are selected in block 810.

After selecting values for the first threshold and the second threshold in either blocks 810 or 812, at a future time the processor may receive another uplink grant from the first network in block 602 of the method 601. In this manner, the method 800 may be used to adjust the behavior of the first subscription depending on whether the first network is utilizing adaptive HARQ and DTX detection for uplink communications.

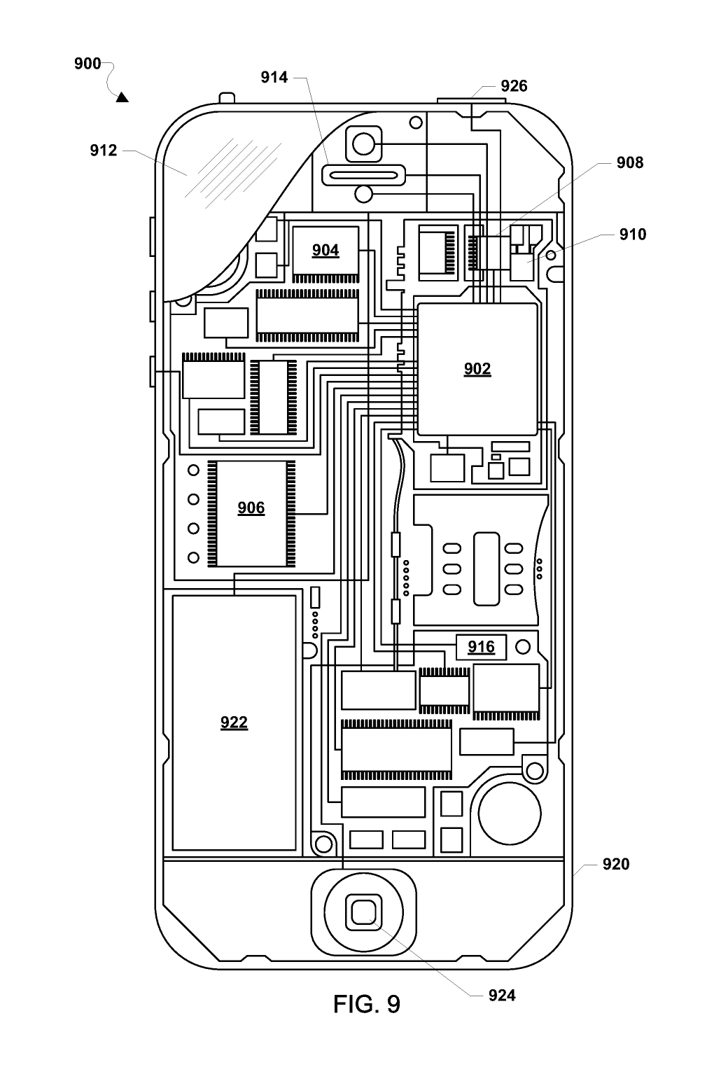

Various embodiments may be implemented in any of a variety of communication devices, an example of which (e.g., multi-SIM mobile communication device 900) is illustrated in FIG. 9. With reference to FIGS. 1-2 and 4-9, the multi-SIM mobile communication device 900 may be similar to the mobile communication devices 110, 120, 200, 402, and 502 as described. As such, the multi-SIM mobile communication device 900 may implement the methods 600, 601, 700, and 800 according to various embodiments.

The multi-SIM mobile communication device 900 may include a processor 902 coupled to a touchscreen controller 904 and an internal memory 906. The processor 902 may be one or more multi-core integrated circuits designated for general or specific processing tasks. The internal memory 906 may be volatile or non-volatile memory, and may also be secure and/or encrypted memory, or unsecure and/or unencrypted memory, or any combination thereof. The touchscreen controller 904 and the processor 902 may also be coupled to a touchscreen panel 912, such as a resistive-sensing touchscreen, capacitive-sensing touchscreen, infrared sensing touchscreen, etc. Additionally, the display of the multi-SIM mobile communication device 900 need not have touch screen capability.

The multi-SIM mobile communication device 900 may have one or more cellular network transceivers 908 coupled to the processor 902 and to one or more antennas 910 and configured for sending and receiving cellular communications. The one or more transceivers 908 and the one or more antennas 910 may be used with the herein-mentioned circuitry to implement various embodiment methods. The multi-SIM mobile communication device 900 may include one or more SIM cards 916 coupled to the one or more transceivers 908 and/or the processor 902 and may be configured as described herein.

The multi-SIM mobile communication device 900 may also include speakers 914 for providing audio outputs. The multi-SIM mobile communication device 900 may also include a housing 920, constructed of a plastic, metal, or a combination of materials, for containing all or some of the components discussed herein. The multi-SIM mobile communication device 900 may include a power source 922 coupled to the processor 902, such as a disposable or rechargeable battery. The rechargeable battery may also be coupled to the peripheral device connection port to receive a charging current from a source external to the multi-SIM mobile communication device 900. The multi-SIM mobile communication device 900 may also include a physical button 924 for receiving user inputs. The multi-SIM mobile communication device 900 may also include a power button 926 for turning the multi-SIM mobile communication device 900 on and off.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configurations. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc in which disks usually reproduce data magnetically, while discs reproduce data optically with lasers. Combinations of the storage media are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to some embodiments without departing from the spirit or scope of the written description. Thus, the present disclosure is not intended to be limited to the embodiments shown herein but is to be accorded the widest scope consistent with the following claims and the principles and novel features disclosed herein.

What is claimed is:

1. A method for managing uplink transmissions in a mobile communication device, comprising:
receiving, on a first subscription of the mobile communication device, an uplink grant from a first network;
determining whether a tune-away from the first subscription to a second subscription of the mobile communication device is scheduled to occur during reception of a response message sent from the first network following an initial transmission of a data packet according to the uplink grant; and
using a block error rate and a buffer status report index of a connection between the first subscription and the first network to determine how to manage uplink transmissions following the tune-away.

2. The method of claim 1, wherein using the block error rate and the buffer status report index of the connection between the first subscription and the first network to determine how to manage uplink transmissions following the tune-away comprises:
comparing the block error rate of the connection between the first subscription and the first network to a first threshold in response to determining that the tune-away is scheduled to occur during reception of the response message;
comparing the buffer status report index of the connection to a second threshold; and
operating as if the response message transmitted during the tune-away was an acknowledgement when the block error rate is less than the first threshold and the buffer status report index is equal to or greater than the second threshold.

3. The method of claim 2, further comprising:
blanking a next transmission to the first network following the tune-away;
determining whether the first network sends a non-acknowledgement response message after blanking the next transmission; and
waiting for additional control instructions from the first network in response to determining that the first network did not send a non-acknowledgement response message after blanking the next transmission.

4. The method of claim 3, further comprising:
resuming transmission based on the uplink grant in response to determining that the first network sent a non-acknowledgement response message after blanking the next transmission.

5. The method of claim 2, wherein using a block error rate and a buffer status report index of a connection between the first subscription and the first network to determine how to manage uplink transmissions following the tune-away further comprises:
operating as if the response message transmitted during the tune-away was a non-acknowledgement or an acknowledgement based on a predetermined ratio when the block error rate is equal to or greater than the first threshold or the buffer status report index is less than the second threshold; and
retransmitting the data packet based on the uplink grant.

6. The method of claim 2, further comprising:
determining values for the first threshold and the second threshold based on whether the first network is utilizing adaptive hybrid automatic repeat request (HARQ) and discontinuous transmission (DTX) for uplink communications.

7. The method of claim 6, wherein determining values for the first threshold and the second threshold further comprises:
receiving, on the first subscription, an initial uplink grant from the first network;
blanking a first transmission in response to receiving the initial uplink grant;
determining whether the first network retransmits the initial uplink grant after blanking the first transmission;
selecting a first value for the first threshold and a third value for the second threshold in response to determining that the first network retransmits the initial uplink grant; and
selecting a second value for the first threshold and a fourth value for the second threshold in response to determining that the first network does not retransmit the initial uplink grant.

8. The method of claim 7, wherein the second value is less than the first value, and the fourth value is less than the third value.

9. The method of claim 1, further comprising:
determining whether the tune-away is scheduled to occur during the initial transmission of the data packet according to the uplink grant; and
pausing building of the data packet in response to determining that the tune-away is scheduled to occur during the initial transmission of the data packet.

10. The method of claim 9, further comprising:
receiving, on the first subscription, the response message from the first network after the tune-away is complete, wherein the response message includes a new uplink grant; and
transmitting the data packet based on the response message.

11. A mobile communication device, comprising:
a radio frequency (RF) resource;
a processor coupled to the RF resource, configured to connect to a first subscriber identity module (SIM) associated with a first subscription and to a second SIM associated with a second subscription, and configured with processor-executable instructions to perform operations comprising:
receiving, on the first subscription, an uplink grant from a first network;
determining whether a tune-away from the first subscription to the second subscription is scheduled to occur during reception of a response message sent from the first network following an initial transmission of a data packet according to the uplink grant; and
using a block error rate and a buffer status report index of a connection between the first subscription and the first network to determine how to manage uplink transmissions following the tune-away.

12. The mobile communication device of claim 11, wherein the processor is further configured with processor-executable instructions to use the block error rate and the buffer status report index of the connection between the first subscription and the first network to determine how to manage uplink transmissions following the tune-away by:
comparing the block error rate to a first threshold in response to determining that the tune-away is scheduled to occur during reception of the response message;
comparing the buffer status report index to a second threshold; and
operating as if the response message transmitted during the tune-away was an acknowledgement when the block error rate is less than the first threshold and the buffer status report index is equal to or greater than the second threshold.

13. The mobile communication device of claim 12, wherein the processor is further configured with processor-executable instructions to perform operations comprising:
blanking a next transmission to the first network following the tune-away;
determining whether the first network sends a non-acknowledgement response message after blanking the next transmission; and
waiting for additional control instructions from the first network in response to determining that the first network did not send a non-acknowledgement response message after blanking the next transmission.

14. The mobile communication device of claim 13, wherein the processor is further configured with processor-executable instructions to perform operations comprising:
resuming transmission based on the uplink grant in response to determining that the first network sent a non-acknowledgement response message after blanking the next transmission.

15. The mobile communication device of claim 12, wherein the processor is further configured with processor-executable instructions to perform operations comprising:
operating as if the response message transmitted during the tune-away was a non-acknowledgement when the block error rate is equal to or greater than the first threshold or the buffer status report index is less than the second threshold; and
retransmitting the data packet based on the uplink grant.

16. The mobile communication device of claim 12, wherein the processor is further configured with processor-executable instructions to perform operations comprising:
determining values for the first threshold and the second threshold based on whether the first network is utilizing adaptive hybrid automatic repeat request (HARQ) and discontinuous transmission (DTX) for uplink communications.

17. The mobile communication device of claim 16, wherein the processor is further configured with processor-executable instructions to determine values for the first threshold and the second threshold further by:
receiving, on the first subscription, an initial uplink grant from the first network;
blanking a first transmission in response to receiving the initial uplink grant;
determining whether the first network retransmits the initial uplink grant after blanking the first transmission;
selecting a first value for the first threshold and a third value for the second threshold in response to determining that the first network retransmits the initial uplink grant; and
selecting a second value for the first threshold and a fourth value for the second threshold in response to determining that the first network does not retransmit the initial uplink grant.

18. The mobile communication device of claim 17, wherein the second value is less than the first value, and the fourth value is less than the third value.

19. The mobile communication device of claim 11, wherein the processor is further configured with processor-executable instructions to perform operations comprising:
determining whether the tune-away is scheduled to occur during the initial transmission of the data packet according to the uplink grant; and
pausing building of the data packet in response to determining that the tune-away is scheduled to occur during the initial transmission of the data packet.

20. The mobile communication device of claim 19, wherein the processor is further configured with processor-executable instructions to perform operations comprising:
receiving, on the first subscription, the response message from the first network after the tune-away is complete, wherein the response message includes a new uplink grant; and
transmitting the data packet based on the response message.

21. A non-transitory computer readable storage medium having stored thereon processor-executable software instructions configured to cause a processor of a mobile communication device to perform operations comprising:
receiving, on a first subscription of the mobile communication device, an uplink grant from a first network;
determining whether a tune-away from the first subscription to a second subscription of the mobile communication device is scheduled to occur during reception of a response message sent from the first network following an initial transmission of a data packet according to the uplink grant; and
using a block error rate and a buffer status report index of a connection between the first subscription and the first network to determine how to manage uplink transmissions following the tune-away.

22. The non-transitory computer readable storage medium of claim 21, wherein the stored processor-executable software instructions are configured to cause the processor to perform operations such that using the block error rate and the buffer status report index of the connection between the first subscription and the first network to determine how to manage uplink transmissions following the tune-away comprises:
comparing the block error rate to a first threshold in response to determining that the tune-away is scheduled to occur during reception of the response message;
comparing the buffer status report index to a second threshold; and
operating as if the response message transmitted during the tune-away was an acknowledgement when the block error rate is less than the first threshold and the buffer status report index is equal to or greater than the second threshold.

23. The non-transitory computer readable storage medium of claim 22, wherein the stored processor-executable software instructions are configured to cause the processor to perform operations further comprising:
blanking a next transmission to the first network following the tune-away;
determining whether the first network sends a non-acknowledgement response message after blanking the next transmission; and
waiting for additional control instructions from the first network in response to determining that the first network did not send a non-acknowledgement response message after blanking the next transmission.

24. The non-transitory computer readable storage medium of claim 23, wherein the stored processor-executable software instructions are configured to cause the processor to perform operations further comprising:
resuming transmission based on the uplink grant in response to determining that the first network sent a non-acknowledgement response message after blanking the next transmission.

25. The non-transitory computer readable storage medium of claim 22, wherein the stored processor-executable software instructions are configured to cause the processor to perform operations further comprising:
operating as if the response message transmitted during the tune-away was a non-acknowledgement when the block error rate is equal to or greater than the first threshold or the buffer status report index is less than the second threshold; and
retransmitting the data packet based on the uplink grant.

26. The non-transitory computer readable storage medium of claim 22, wherein the processor is further configured with processor-executable instructions to perform operations comprising:
determining values for the first threshold and the second threshold based on whether the first network is utilizing adaptive hybrid automatic repeat request (HARQ) and discontinuous transmission (DTX) for uplink communications.

27. The non-transitory computer readable storage medium of claim 26, wherein the stored processor-executable software instructions are configured to cause the processor to perform operations such that determining values for the first threshold and the second threshold comprises:
receiving, on the first subscription, an initial uplink grant from the first network;
blanking a first transmission in response to receiving the initial uplink grant;
determining whether the first network retransmits the initial uplink grant after blanking the first transmission;
selecting a first value for the first threshold and a third value for the second threshold in response to determining that the first network retransmits the initial uplink grant; and
selecting a second value for the first threshold and a fourth value for the second threshold in response to determining that the first network does not retransmit the initial uplink grant.

28. The non-transitory computer readable storage medium of claim 21, wherein the stored processor-executable software instructions are configured to cause the processor to perform operations further comprising:
determining whether the tune-away is scheduled to occur during the initial transmission of the data packet according to the uplink grant; and
pausing building of the data packet in response to determining that the tune-away is scheduled to occur during the initial transmission of the data packet.

29. The non-transitory computer readable storage medium of claim 28, wherein the stored processor-executable software instructions are configured to cause the processor to perform operations further comprising:
receiving, on the first subscription, the response message from the first network after the tune-away is complete, wherein the response message includes a new uplink grant; and
transmitting the data packet based on the response message.

30. A mobile communication device, comprising:
means for receiving, on a first subscription of the mobile communication device, an uplink grant from a first network;
means for determining whether a tune-away from the first subscription to a second subscription of the mobile communication device is scheduled to occur during reception of a response message sent from the first network following an initial transmission of a data packet according to the uplink grant; and
means for using a block error rate and a buffer status report index of a connection between the first subscription and the first network to determine how to manage uplink transmissions following the tune-away.
